(19) United States
(12) Patent Application Publication
(10) Pub. No.: US 2014/0113164 A1
(43) Pub. Date: Apr. 24, 2014

(54) CURRENT INTERRUPTING DEVICE OF A SEALED BATTERY, SEALED BATTERY HAVING CURRENT INTERRUPTING DEVICE, AND MANUFACTURING METHOD OF SEALED BATTERY

(71) Applicant: Hiroshi NAGATA, Toyota-shi (JP)

(72) Inventor: Hiroshi NAGATA, Toyota-shi (JP)

(73) Assignee: TOYOTA JIDOSHA KABUSHIKI KAISHA, Toyota-shi (JP)

(21) Appl. No.: 14/056,244

(22) Filed: Oct. 17, 2013

(30) Foreign Application Priority Data
Oct. 19, 2012 (JP) 2012-232192

(51) Int. Cl. H01M 2/34

(52) U.S. Cl. CPC H01M 2/345
USPC 429/61; 29/623.2

(57) ABSTRACT

A current interrupting device of a sealed battery includes a conductive member that is electrically connected to an external terminal arranged on an outside portion of a battery case; and a reversing plate that is electrically connected to a collector terminal arranged inside of the battery case, and that electrically cuts off the conductive member from the collector terminal by deforming in response to an increase in pressure inside of the battery case. The current interrupting device is attached to an outside portion of the battery case.

### INCORPORATION BY REFERENCE

The disclosure of Japanese Patent Application No. 2012-232192 filed on Oct. 19, 2012 including the specification, drawings and abstract is incorporated herein by reference in its entirety.

### BACKGROUND OF THE INVENTION

1. Field of the Invention

The invention relates to technology of a current interrupting device of a sealed battery, a sealed battery provided with this current interrupting device, and a manufacturing method of this sealed battery.

2. Description of Related Art

A sealed battery is a battery configured with an electrode body that includes a positive electrode and a negative electrode sealed, together with an electrolyte, inside a battery case. A lithium-ion secondary battery is one well-known example of a sealed battery. Some sealed batteries are provided with a current interrupting device that detects overcharge and interrupts the flow of current. One such known current interrupting device is a pressure-type current interrupting device that physically interrupts the flow of current when the internal pressure of the battery case becomes higher than a set pressure (for example, Japanese Patent Application Publication No. 2008-066254 (JP 2008-066254 A)).

A related pressure-type current interrupting device such as that described in JP 2008-066254 A includes a conductive member that is electrically connected to an external terminal of a battery case, and a reversing plate that is electrically connected to a collector terminal arranged inside the battery case. The pressure-type current interrupting device is configured to electrically cut off the conductive member from the collector terminal by the reversing plate deforming according to an increase in pressure inside the battery case.

However, with the related pressure-type current interrupting device such as that described in JP 2008-066254 A, the conductive member and the reversing plate that form the pressure-type current interrupting device are arranged inside the battery case, so the pressure-type current interrupting device must be assembled in a battery cell main body at the stage when the battery cell main body is assembled.

With a manufacturing method in which the pressure-type current interrupting device is attached at the stage when the battery cell main body is assembled in this way, a lithium-ion secondary battery that is provided with the pressure-type current interrupting device must be manufactured in a different production line than a lithium-ion secondary battery that is not provided with the pressure-type current interrupting device, so production efficiency is poor.

Also, with a lithium-ion secondary battery in which the conductive member and the reversing plate that form the pressure-type current interrupting device are arranged inside the battery case, the pressure-type current interrupting device must be assembled inside the battery case which is a narrow space, so assembly workability is poor.

### SUMMARY OF THE INVENTION

The invention thus provides a current interrupting device of a sealed battery, a sealed battery provided with this current interrupting device, and a manufacturing method of this sealed battery, in which the current interrupting device is able to be attached after a battery cell main body has been assembled, such that assemblability when manufacturing the current interrupting device and the sealed battery is able to be improved.

A first aspect of the invention relates to a current interrupting device of a sealed battery, that includes a conductive member that is electrically connected to an external terminal arranged on an outside portion of a battery case, and a reversing plate that is electrically connected to a collector terminal arranged inside of the battery case, and that electrically cuts off the conductive member from the collector terminal by deforming in response to an increase in pressure inside of the battery case. Also, the current interrupting device is attached to the outside portion of the battery case.

The current interrupting device may be attached to a receiving portion formed on the lid of the battery case.

A second aspect of the invention relates to a sealed battery to which the current interrupting device described above is attached.

A third aspect of the invention relates to a manufacturing method of a sealed battery. This manufacturing method includes joining a lid to which a collector terminal is attached to a battery case containing an electrode body and an electrolyte; attaching a seal member to an outer peripheral edge portion of a current interrupting device including a conductive member and a reversing plate; mounting the current interrupting device to which the seal member is attached, to the lid; joining, via the seal member, the lid to a retaining member such that the current interrupting device is sandwiched between the lid and the retaining member; joining the collector terminal to the reversing plate; and joining the conductive member to an external terminal arranged on an outside portion of the battery case.

According to the current interrupting device of a sealed battery, a sealed battery provided with this current interrupting device, and a manufacturing method of this sealed battery of the invention, the current interrupting device is able to be attached after a battery cell main body has been assembled, so assemblability when manufacturing the current interrupting device and the sealed battery is able to be improved.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view showing a frame format of the structure of a lithium-ion secondary battery;

FIG. 2 is a view showing a frame format of the surrounding structure of a pressure-type current interrupting device; and

FIG. 3 is a flowchart illustrating the flow of a manufacturing method of the lithium-ion secondary battery.

### DETAILED DESCRIPTION OF EMBODIMENTS

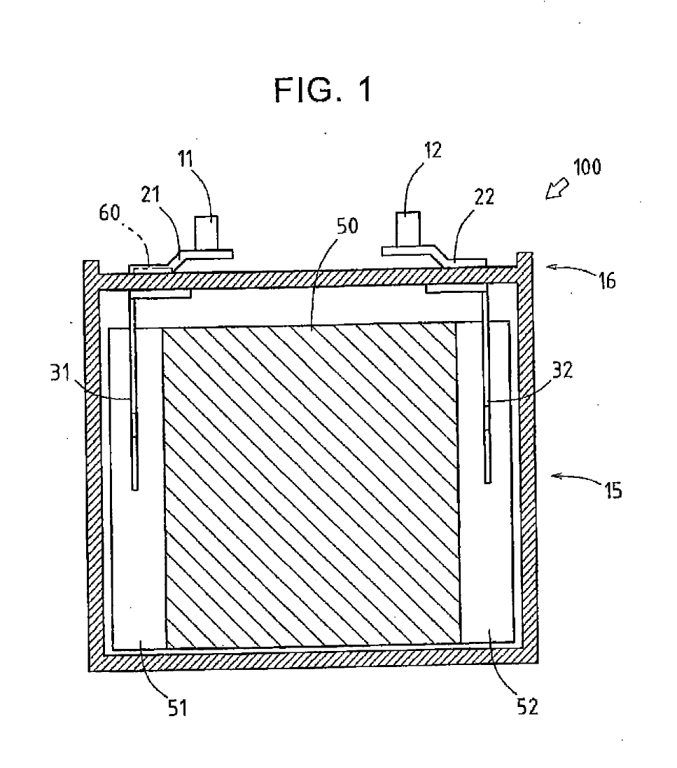

A lithium-ion secondary battery 100 will now be described with reference to FIG. 1. FIG. 1 is a sectional view showing a frame format of the lithium-ion secondary battery 100.

The lithium-ion secondary battery 100 is one example embodiment of the sealed battery of the invention. The lithium-ion secondary battery 100 includes a battery case 15, a lid 16, a positive terminal 11 as an external terminal, a negative terminal 12 as an external terminal, and a rolled electrode body 50 as a collector.

The battery case 15 is configured as a cuboid-shaped square case. The flat rolled electrode body 50 and an electrolyte are housed inside the battery case 15. The lid 16 is configured to block off an open portion that is open in an upper portion of the battery case 15. The positive terminal 11 and the negative terminal 12 that are external terminals are provided on the lid 16. A portion of both the positive terminal 11 and the negative terminal 12 protrudes on the surface side of the lid 16.

A positive collector 51 is exposed on an end portion on one side, in a width direction, of the rolled electrode body 50 that serves as a collector. Meanwhile, a negative collector 52 is exposed on an end portion on the other side, in the width direction, of the rolled electrode body 50 that serves as a collector. A lower terminal 31 as a collector terminal is connected to the positive collector 51, while a lower terminal 32 as a collector terminal is connected to the negative collector 52.

The positive terminal 11 that serves as an external terminal is electrically connected to the positive collector 51 of the rolled electrode body 50 via an upper terminal 21 that serves as a conductive member, a pressure-type current interrupting device 60, and the lower terminal 31 that serves as a collector terminal. The negative terminal 12 that serves as an external terminal is electrically connected to the negative collector 52 of the rolled electrode body 50 via an upper terminal 22 that serves as a conductive member, and the lower terminal 32 that serves as a collector terminal.

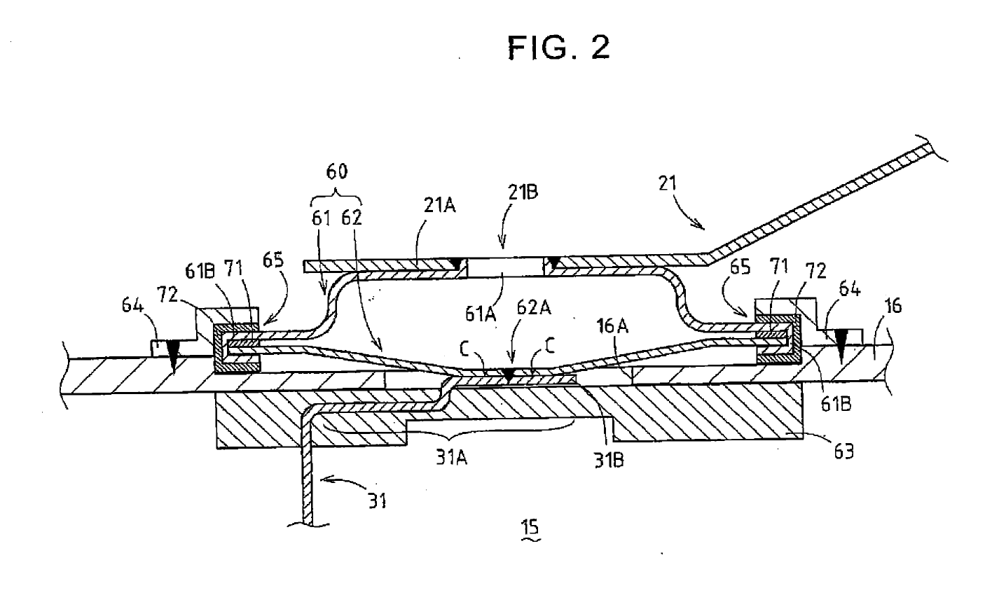

Next, the pressure-type current interrupting device 60 will be described with reference to FIG. 2. FIG. 2 is a sectional view showing a frame format of the surrounding structure of the pressure-type current interrupting device 60.

The pressure-type current interrupting device 60 is one example embodiment of the pressure-type current interrupting device of the invention. The pressure-type current interrupting device 60 is a device that interrupts the flow of current when pressure within the battery case 15 of the lithium-ion secondary battery 100 becomes higher than a set pressure. In this example embodiment, the pressure-type current interrupting device 60 is provided on the positive electrode side of the lithium-ion secondary battery 100, but it may also be provided on the negative electrode side.

The pressure-type current interrupting device 60 includes a case 61 that serves as a conductive member, and a reversing plate 62. Hereinafter, the structure around the pressure-type current interrupting device 60, also including that of the pressure-type current interrupting device 60 (i.e., the case 61 and the reversing plate 62), will be described.

The upper terminal 21 that serves as a conductive member is arranged on an outside portion of the battery case 15 and the lid 16, and is joined to the positive terminal 11 so as to be electrically connected thereto (see FIG. 1). The upper terminal 21 is made of copper and includes a lower portion 21A that extends downward on the outside from a portion that is joined to the positive terminal 11, and an open portion 21B formed in the lower portion 21A. A lower surface of the lower portion 21A abuts against an upper surface of the case 61 that will be described later. A protruding portion 61A of the case 61 that will be described later fits into the open portion 21B, and the inner peripheral surface of the open portion 21B is joined to the outer peripheral surface of the protruding portion 61A by welding.

The case 61 is electrically connected to the upper terminal 21 that is arranged on an outside portion of the battery case 15 and the lid 16. The case 61 is made of copper and is formed with a center portion, when viewed from below, having a recessed shape that is recessed upward. The case 61 includes the protruding portion 61A that is formed in substantially the center portion of the recessed portion and protrudes upward, and a folded portion 61B that is formed on an edge portion positioned on the outer peripheral side of the recessed portion. The folded portion 61B is formed with an outer peripheral edge portion of the case 61 folded back toward the inside.

As described above, the upper surface of the recessed portion of the case 61 abuts against the lower surface of the lower portion 21A of the upper terminal 21. The protruding portion 61A of the case 61 fits into the open portion 21B of the upper terminal 21, and the fitting portion of the open portion 21B and the protruding portion 61A is joined by welding.

An outer peripheral edge portion of the reversing plate 62 fits into the folded portion 61B of the case 61. At this folded portion 61B, an upper plate portion positioned above and a lower plate portion positioned below face each other, and the outer peripheral edge portion of the reversing plate 62 fits in between the upper plate portion and the lower plate portion of the folded portion 61B.

A first seal member 71 is interposed between the outer peripheral edge portion of the reversing plate 62 and the upper plate portion of the folded portion 61B. This first seal member 71 seals the fitting portion of the reversing plate 62 and the folded portion 61B of the case 61.

The reversing plate 62 is electrically connected to the lower terminal 31 arranged inside the battery case 15. The reversing plate 62 is made of copper and formed in a generally discoid shape. A recessed portion 62A that is a portion in which the upper surface side is recessed is formed in substantially the center portion of the reversing plate 62. A circular slit C is formed in the recessed portion 62A of the reversing plate 62.

As described above, the edge portion of the reversing plate 62 fits together with the folded portion 61B of the case 61 via the first seal member 71. Also, the generally center portion of the recessed portion 62A of the reversing plate 62 is joined by welding to an upper end portion 31B of the lower terminal 31 that will be described later. The joint between the recessed portion 62A of the reversing plate 62 and the upper end portion 31B of the lower terminal 31 is positioned at an open portion 16A formed in the lid 16.

A holder 63 is attached to the lower surface of the lid 16, and supports the lower terminal 31 inside of the battery case 15. The holder 63 is made of resin and is formed in a generally discoid shape. The lower terminal 31 is inserted through the inside of the holder 63.

The lower terminal 31 that serves as a collector terminal is joined to the positive collector 51 of the rolled electrode body 50 so as to be electrically connected thereto, inside of the battery case 15 (see FIG. 1). The lower terminal 31 is made of copper and is formed in a generally inverted L shape.

The lower terminal 31 includes a horizontal portion 31A that extends in a horizontal direction, and an upper end portion 31B is formed on one side (i.e., the tip end side) of this horizontal portion 31A. The horizontal portion 31A is formed in a shape with a midway portion thereof bent such that a portion on one side (i.e., the tip end side) is positioned higher than the portion on the other side (i.e., the base end side), and the portion on the one side (i.e., the tip end side) that is positioned higher is formed as the upper end portion 31B.

The portion on the other side (i.e., the base end side) of the horizontal portion 31A is inserted through the holder 63, and the upper end portion 31B that is formed by the portion on the one side (i.e., the tip end side) of the horizontal portion 31A is exposed on the upper surface of the holder 63. Also, the upper end portion 31B is positioned inside the open portion 16A of the lid 16.

As described above, the upper end portion 31B of the lower terminal 31 is joined by welding to generally the center portion of the recessed portion 62A of the reversing plate 62.

A retaining member 64 is attached to the lid 16 and forms a receiving portion 65. This retaining member 64 is made of aluminum and is joined to the lid 16 by welding.

The receiving portion 65 is a space that is formed by the retaining member 64 and the lid 16, where the pressure-type current interrupting device 60 (i.e., the case 61 and the reversing plate 62) attaches. The folded portion 61B of the case 61 is fitted to this receiving portion 65 via a second seal member 72.

The second seal member 72 is formed in a sideways U-shape in a sectional view. This second seal member 72 provides a seal between the inside and the outside of the pressure-type current interrupting device 60 in the battery case 15.

Next, the operation of the pressure-type current interrupting device 60 will be described. In FIG. 2, the pressure-type current interrupting device 60 is shown in a normal operating state (i.e., a state in which the pressure-type current interrupting device 60 is not activated), in which the positive terminal 11, the upper terminal 21, the case 61, the reversing plate 62, and the lower terminal 32 are electrically connected together.

However, when the pressure within the battery case 15 becomes higher than a set pressure, pressure from the inside is applied to the recessed portion 62A of the reversing plate 62 through the open portion 16A of the lid 16, and as a result, the portion of the reversing plate 62 with the slit C fractures and the reversing plate 62 deforms outward. That is, the pressure-type current interrupting device 60 activates. As a result, the lower terminal 31 becomes electrically cut of from the reversing plate 62 (i.e., the reversing plate 62 becomes disconnected from the lower terminal 31).

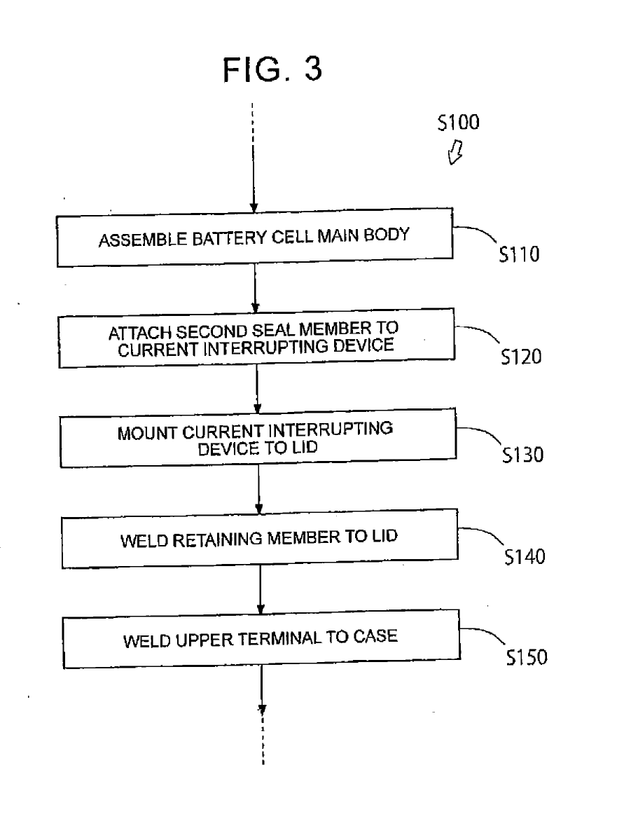

Next, a manufacturing process S100 of a lithium-ion secondary battery will be described with reference to FIG. 3. FIG. 3 is a flowchart illustrating the flow of the manufacturing process S100 of a lithium-ion secondary battery.

The manufacturing process S100 of the lithium-ion secondary battery is a process for manufacturing the lithium-ion secondary battery 100 provided with the pressure-type current interrupting device 60 of the example embodiment.

In step S110, the battery cell main body (i.e., the battery case 15, the lid 16, the lower terminal 31, and the holder 63) are assembled. That is, the holder 63 through which the lower terminal 31 is inserted is attached to the lid 16, the lower terminal 31 is joined to the positive collector 51 of the rolled electrode body 50, and the rolled electrode body 50 is assembled to the lid 16. Then, the rolled electrode body 50 that is assembled to the lid 16 is housed inside the battery case 15, and moreover, an electrolyte is filled into the battery case 15, after which the lid 16 is joined to the battery case 15, thus sealing the battery case 15.

In step S120, the second seal member 72 is attached from the outside to the outer peripheral edge portion (i.e., the folded portion 61B of the case 61) of the pressure-type current interrupting device 60. In step S130, the pressure-type current interrupting device 60 (i.e. the case 61 and the reversing plate 62) to which the second seal member 72 is attached is mounted to the lid 16. In this case, the pressure-type current interrupting device 60 is mounted so that the outer peripheral edge portion of the pressure-type current interrupting device 60 is positioned in the receiving portion 65 of the lid 16 (or more accurately, in the portion where the receiving portion 65 is formed by the retaining member 64 being joined to the lid 16).

In step S140, the retaining member 64 is joined to the lid 16 by welding. Also, the recessed portion 62A of the reversing plate 62 and the upper end portion 31B of the lower terminal 31 are joined together by welding. In step S150, the open portion 21B of the upper terminal 21 and the protruding portion 61A of the case 61 are joined together by welding. In this way, the lithium-ion secondary battery 100 is manufactured by attaching the pressure-type current interrupting device 60 to the outside of the battery cell main body after the battery cell main body has been assembled.

Next, the effects of the pressure-type current interrupting device 60 of the lithium-ion secondary battery 100 will be described. With the pressure-type current interrupting device 60 of the lithium-ion secondary battery 100, it is possible to attach the pressure-type current interrupting device 60 (i.e., the case 61 and the reversing plate 62) to the battery cell main body after the battery cell main body (i.e., the battery case 15, the lid 16, the lower terminal 31, and the holder 63 and the like) has been assembled.

Therefore, the lithium-ion secondary battery 100 that is provided with the pressure-type current interrupting device 60 and the lithium-ion secondary battery 100 that is not provided with the pressure-type current interrupting device 60 are both able to be manufactured in the same production line. Also, the pressure-type current interrupting device does not have to be assembled in the narrow space inside the battery case 15 as it does in the related art, so workability when manufacturing the pressure-type current interrupting device 60 and the lithium-ion secondary battery 100 is able to be improved.

What is claimed is:

1. A current interrupting device of a sealed battery, comprising:
a conductive member that is electrically connected to an external terminal arranged on an outside portion of a battery case; and
a reversing plate that is electrically connected to a collector terminal arranged inside of the battery case, and that electrically cuts off the conductive member from the collector terminal by deforming in response to an increase in pressure inside of the battery case,
wherein the current interrupting device is attached to an outside portion of the battery case.

2. The current interrupting device according to claim 1, wherein the current interrupting device is attached to a receiving portion formed on a lid of the battery case.

3. The current interrupting device according to claim 2, wherein the current interrupting device is fitted to the receiving portion via a seal member.

4. A sealed battery to which the current interrupting device according to claim 1 is attached.

5. A manufacturing method of a sealed battery, comprising:
joining a lid to which a collector terminal is attached to a battery case containing an electrode body and an electrolyte;
attaching a seal member to an outer peripheral edge portion of a current interrupting device including a conductive member and a reversing plate;
mounting the current interrupting device to which the seal member is attached, to the lid;
joining, via the seal member, the lid to a retaining member such that the current interrupting device is sandwiched between the lid and the retaining member;
joining the collector terminal to the reversing plate; and
joining the conductive member to an external terminal arranged on an outside portion of the battery case.
